(19) United States
(12) Patent Application Publication
(10) Pub. No.: US 2026/0036850 A1
(43) Pub. Date: Feb. 5, 2026

(54) ELECTRONIC DEVICE

(71) Applicant: InnoLux Corporation, Miao-Li County (TW)

(72) Inventors: Chih-Yung HSIEH, Miao-Li County (TW); Ying-Jen CHEN, Miao-Li County (TW); Jen-Hai CHI, Miao-Li County (TW); Chien-Min CHAO, Miao-Li County (TW)

(21) Appl. No.: 19/257,946

(22) Filed: Jul. 2, 2025

Related U.S. Application Data
(60) Provisional application No. 63/678,216, filed on Aug. 1, 2024.

(30) Foreign Application Priority Data
Feb. 8, 2025 (CN) 202510139892.1

(51) Int. Cl. G02F 1/1343; E06B 9/24

(52) U.S. Cl. CPC G02F 1/134309; E06B 9/24; G02F 1/13439; E06B 2009/2464

(57) ABSTRACT

An electronic device includes: a first substrate; a second substrate opposite to the first substrate; a light modulation layer disposed between the first substrate and the second substrate; and an antenna structure having a first electrode and a second electrode, wherein the first electrode is disposed on a surface of the first substrate away from the light modulation layer, the second electrode is disposed between the first substrate and the light modulation layer, and the second electrode is used to receive a ground voltage.

### CROSS-REFERENCE TO RELATED APPLICATIONS

This application claims the benefit of filing date of U.S. Provisional Application Ser. No. 63/678,216 filed on Aug. 1, 2024 under 35 USC § 119(e)(1), and also claims the benefit of the Chinese Patent Application Serial Number 202510139892.1, filed on Feb. 8, 2025, the subject matter of which is incorporated herein by reference.

### BACKGROUND

### Field of the Disclosure

The present disclosure relates to an electronic device and, more particularly, to an electronic device having an antenna structure.

### Description of Related Art

Typically, the adjustable window may be controlled by electric fields to change the light transmittance so as to present different optical states, such as light-transmitting state or light-shielding state.

However, current adjustable windows have many disadvantages, such as poor signal (for example, high-frequency signal) penetration. Therefore, there is an urgent need to provide a novel electronic device to alleviate and/or obviate the aforementioned defects.

### SUMMARY

The present disclosure provides an electronic device, which includes: a first substrate; a second substrate opposite to the first substrate; a light modulation layer disposed between the first substrate and the second substrate; and an antenna structure having a first electrode and a second electrode, wherein the first electrode is disposed on a surface of the first substrate away from the light modulation layer, the second electrode is disposed between the first substrate and the light modulation layer, and the second electrode is used to receive a ground voltage.

Other novel features of the disclosure will become more apparent from the following detailed description when taken in conjunction with the accompanying drawings.

### BRIEF DESCRIPTION OF DRAWINGS

FIG. 1A is a cross-sectional schematic diagram of a portion of an electronic device according to an embodiment of the present disclosure;

FIG. 1B is a schematic top view of a portion of an electronic device according to an embodiment of the present disclosure;

FIG. 2A is a schematic cross-sectional view of a portion of an electronic device according to an embodiment of the present disclosure;

FIG. 2B is a schematic top view of a portion of an electronic device according to an embodiment of the present disclosure;

FIG. 3 is a schematic cross-sectional view of a portion of an electronic device according to an embodiment of the present disclosure;

FIG. 4A is a schematic cross-sectional view of a portion of an electronic device according to an embodiment of the present disclosure;

FIG. 4B is a schematic top view of a portion of an electronic device according to an embodiment of the present disclosure;

FIG. 5A is a schematic cross-sectional view of a portion of an electronic device according to an embodiment of the present disclosure;

FIG. 5B is a schematic top view of a portion of an electronic device according to an embodiment of the present disclosure;

FIG. 6A is a three-dimensional schematic diagram of a portion of an electronic device according to an embodiment of the present disclosure;

FIG. 6B is a three-dimensional schematic diagram of a portion of an electronic device according to an embodiment of the present disclosure; and

FIG. 7A and FIG. 7B are respectively signal transmission block diagrams according to an embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

The embodiments of the present disclosure may be understood together with the drawings, and the drawings of the present disclosure are also regarded as part of the disclosure description. It should be understood that the drawings of the present disclosure are not in scale and, in fact, the dimensions of elements may be arbitrarily enlarged or reduced in order to clearly illustrate features of the present disclosure. In addition, directional terms mentioned in the present disclosure, such as “up”, “down”, “front”, “rear”, “left”, “right”, etc., only refer to the directions of the drawings. Accordingly, the directional term used is illustrative, not limiting, of the present disclosure. In the drawings, various figures illustrate the general characteristics of methods, structures and/or materials used in particular embodiments. However, these drawings should not be construed to define or limit the scope or nature encompassed by these embodiments. For example, the relative sizes, thicknesses and positions of various layers, regions and/or structures may be reduced or enlarged for clarity.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged “on” other structures, it may mean that a certain structure is “directly” on other structures, or it means that a certain structure is “indirectly” on other structures; that is, at least one structure is sandwiched, in between a certain structure and other structures.

In addition, it should be understood that, in the specification and claims, unless otherwise specified, ordinal numbers, such as “first” and “second”, used herein are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may also include the situation that both structures are movable, or both structures are fixed. In addition, the term “couple” includes any direct and indirect means of electrical connection.

In the description, the terms “almost”, “about”, “approximately” or “substantially” usually means within 10%, 5%, 3%, 2%, 1% or 0.5% of a given value or range. In addition, there may be a certain error in any two values or directions used for comparison. If the first value is equal to the second value, it implies that there may be an error of about 10% between the first value and the second value. If the first direction is perpendicular to the second direction, the angle between the first direction and the second direction may be 80 to 100 degrees. If the first direction is parallel to the second direction, the angle between the first direction and the second direction may be 0 to 10 degrees. In addition, any two values or directions used for comparison may have certain errors. In addition, the terms “the given range is from the first value to the second value” and “the given range falls within the range from the first value to the second value” indicate that the given range includes the first value, the second value and other values between the first value and the second value.

It should be understood that, according to the embodiments of the present disclosure, an optical microscope (OM), a scanning electron microscope (SEM), a film thickness profiler (a-step), an ellipse thickness gauge or other suitable measurement means may be used to measure the depth, thickness, width or height of each component, or the spacing or distance between components. In details, according to some embodiments, a scanning electron microscope may be used to obtain a cross-sectional structural image including the components to be measured, and measure the thickness, length or width of each component, or the angle or distance between components.

Throughout the specification and the appended claims, certain terms may be used to refer to specific components. Those skilled in the art will understand that electronic device manufacturers may refer to the same components by different names. The present disclosure does not intend to distinguish between components that have the same function but have different names. In the following description and claims, words such as “comprising”, “containing” and “having” are open-ended words, and should be interpreted as meaning “including but not limited to”. Accordingly, when the terms “comprising”, “containing” and/or “having” are used in the description of the present disclosure, they specify the presence of the corresponding features, regions, steps, operations and/or components, but do not exclude the presence of one or more corresponding features, regions, steps, operations and/or components.

Unless otherwise defined, all terms (including technical and scientific terms) used herein have the same meaning as commonly understood by those skilled in the art related to the present disclosure. It can be understood that these terms, such as those defined in commonly used dictionaries, should be interpreted as having meaning consistent with the relevant technology and the background or context of the present disclosure, and should not be interpreted in an idealized or excessively formal way. Unless there is a special definition in the embodiment of the present disclosure. The electronic device of the present disclosure may include an electronic component. The electronic component may include a passive component, an active component, or a combination thereof, such as a capacitor, a resistor, an inductor, a varactor diode, a variable capacitor, a filter, a diode, a transistor, a sensor, a micro-electromechanical system component (MEMS), a liquid crystal chip, etc., but not limited thereto. The diode may include a light emitting diode or a non-light emitting diode. The diode includes a P-N junction diode, a PIN diode or a constant current diode. The light emitting diode may include, for example, an organic light emitting diode (OLED), a mini LED, a micro LED, a quantum dot LED, fluorescence, phosphor or other suitable materials, or a combination thereof, but not limited thereto. The sensor may include, for example, a capacitive sensor, an optical sensor, an electromagnetic sensor, a fingerprint sensor (FPS), a touch sensor, an antenna, or a pen sensor, but not limited thereto. In the following description, a display device will be used as an electronic device to illustrate the present disclosure, but not limited thereto.

It is noted that the following are exemplary embodiments of the present disclosure, but the present disclosure is not limited thereto, while a feature of some embodiments can be applied to other embodiments through suitable modification, substitution, combination, or separation. In addition, the present disclosure can be combined with other known structures to form further embodiments. It should be noted that the technical solutions provided in different embodiments below may be replaced, combined or mixed with each other to constitute another embodiment without violating the spirit of the present disclosure.

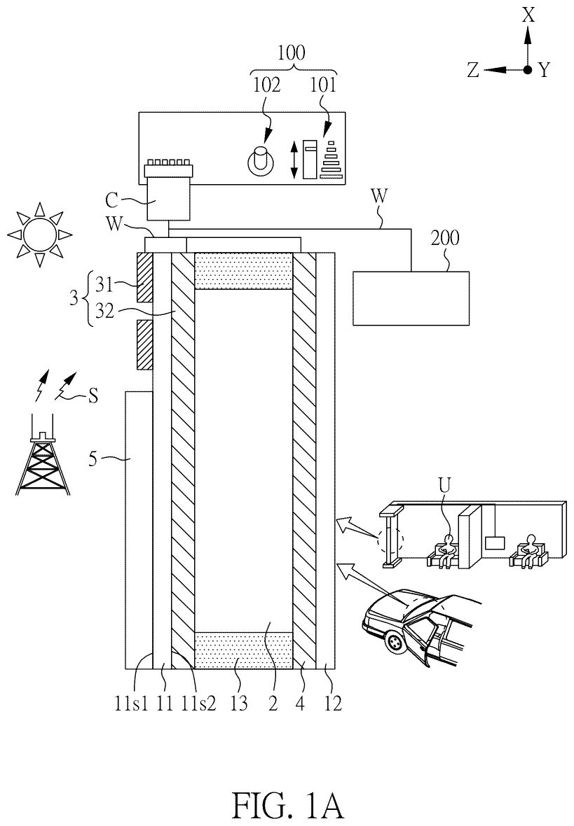

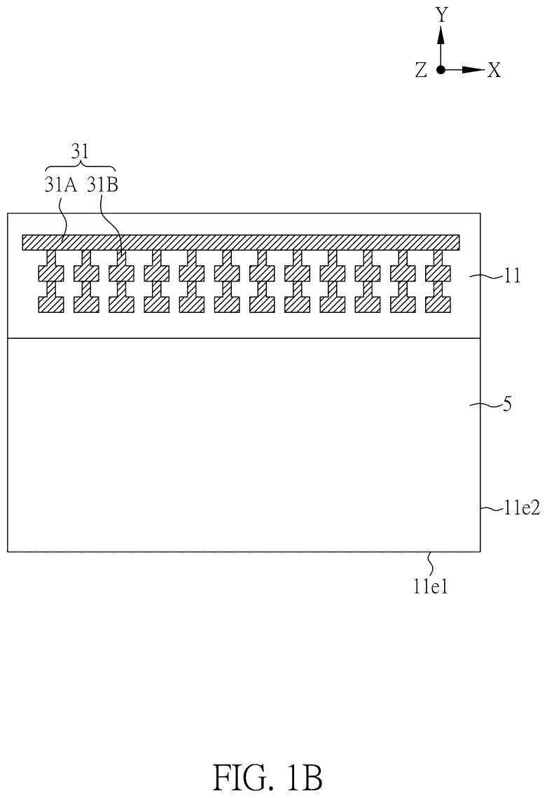

FIG. 1A is a cross-sectional schematic diagram of a portion of an electronic device according to an embodiment of the present disclosure. FIG. 1B is a schematic top view of a portion of an electronic device according to an embodiment of the present disclosure.

In one embodiment of the present disclosure, as shown in FIG. 1A, the electronic device may include: a first substrate 11; a second substrate 12 opposite to the first substrate 11; a light modulation layer 2 disposed between the first substrate 11 and the second substrate 12; and an antenna structure 3 having a first electrode 31 and a second electrode 32, wherein the first electrode 31 is disposed on a surface 11s1 of the first substrate 11 away from the light modulation layer 2, the second electrode 32 is disposed between the first substrate 11 and the light modulation layer 2, and the second electrode 32 is used to receive a ground voltage. By combining the antenna structure 3 with the light modulation layer 2, the electronic device may have the function of receiving and/or sending signals while achieving a light-shielding or light-transmitting effect.

As shown in FIG. 1A, the first substrate 11 has a surface 11s1 away from the light modulation layer 2 and a surface 11s2 adjacent to the light modulation layer 2, wherein the first electrode 31 is disposed adjacent to the surface 11s1, and the second electrode 32 is disposed adjacent to the surface 11s2. In one embodiment of the present disclosure, the first electrode 31 may contact the surface 11s1 of the first substrate 11, and the second electrode 32 may contact the surface 11s2 of the first substrate 11, but the present disclosure is not limited thereto.

In one embodiment of the present disclosure, as shown in FIG. 1A, the electronic device may also include a further electrode 4 disposed between the second substrate 12 and the light modulation layer 2, wherein the second electrode 32 and the further electrode 4 may serve as electrodes for driving the light modulation layer 2; that is, the second electrode 32 and the further electrode 4 may be used to drive the light modulation layer 2. In more detail, by applying voltage to the second electrode 32 and the further electrode 4, the light modulation layer 2 may be switched between a light-transmitting state and a non-light-transmitting state (such as a color-changing state, a light-shielding state or a haze state), thereby enabling the electronic device to achieve the effect of a light-transmitting state and a non-light-transmitting state (such as a color-changing state, a light-shielding state or a haze state). In this embodiment, since the second electrode 32 may be used as the antenna structure 3 and the electrode for driving the light modulation layer 2 at the same time, it is able to realize a thin electronic device, and achieve the effects of saving cost and/or simplifying the manufacturing process.

In one embodiment of the present disclosure, as shown in FIG. 1A, the electronic device may further include a hub 100, which may be electrically connected to the first electrode 31, the second electrode 32 and/or the further electrode 4 through a circuit board C (such as a flexible circuit board) and a wire W, thereby controlling the light modulation layer 2 and/or the antenna structure 3. In more detail, the hub 100 may selectively include a dimming system 101 and/or an antenna switch 102, but it is not limited thereto. The dimming system 101 may include, for example, a dimming button. By turning the dimming button, the electric field strength applied between the second electrode 32 and the further electrode 4 may be adjusted, so that the light modulation layer 2 presents different levels of light-transmitting state and non-light-transmitting state (such as color-changing state, light-shielding state or haze state) according to the electric field strength. The antenna switch 102 may be, for example, a button, and the antenna structure 3 is driven to receive or send a signal by pressing the button, but the present disclosure is not limited thereto.

In one embodiment of the present disclosure, as shown in FIG. 1A, the electronic device may further include a hub 100 and a client equipment 200, and the client equipment 200 is electrically connected to the hub 100. In more detail, the client equipment 200 may be electrically connected to the hub 100 through the circuit board C and the wire W to convert the signal provided by the hub 100 into a signal required by the user (such as a Wi-Fi signal, etc.) and provide the signal to the user for use. In one embodiment of the present disclosure, as shown in FIG. 1A, a mobile communication signal S (for example, a 4G signal, a 5G signal, and/or a 6G signal, etc.) outside the electronic device may be received through the antenna structure 3 for being transmitted to the hub 100. The hub 100 may provide the received signal to the client equipment 200. The client equipment 200 may convert the signal into, for example, a Wi-Fi signal and provide the Wi-Fi signal to the user inside the electronic device for use, thereby alleviating the problem of poor signal penetration of the electronic device. Therefore, the electronic device of the present disclosure may be applied to, for example, smart windows or substrates of buildings, windows or substrates for vehicles (such as cars), or skylights, etc., but the present disclosure is not limited thereto.

In the present disclosure, the materials of the first substrate 11 and the second substrate 12 may be a flexible substrate or a rigid substrate, respectively. The materials of the first substrate 11 and the second substrate 12 may each include glass, quartz, sapphire, ceramic, plastic, polycarbonate (PC), polyimide (PI), polypropylene (PP), polyethylene terephthalate (PET), polymethylmethacrylate (PMMA), other suitable materials or a combination thereof, but the present disclosure is not limited thereto.

In the present disclosure, the light modulation layer 2 may include at least one of a liquid crystal material, a suspended particle device (SPD) or an electrochromic material. The suitable liquid crystal materials may include, for example, polymer-dispersed liquid crystal (PDLC), polymer network liquid crystal (PNLC), cholesteric texture liquid crystal, twisted nematic liquid crystal (TN LC), super twisted nematic liquid crystal (STN LC), other suitable liquid crystal materials or a combination thereof, but the present disclosure is not limited thereto.

In the present disclosure, the material of the first electrode 31 may include a metal material, a metal oxide material, an alloy thereof or a combination thereof, for example, may include gold, silver, copper, palladium, platinum, ruthenium, aluminum, cobalt, nickel, titanium, molybdenum, manganese, indium zinc oxide (IZO), indium tin oxide (ITO), indium tin zinc oxide (ITZO), indium gallium zinc oxide (IGZO), or aluminum zinc oxide (AZO), but the present disclosure is not limited thereto. In the present disclosure, the materials of the second electrode 32 and the further electrode 4 may each include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto. When the material of the first electrode 31 is an opaque material, the pattern of the first electrode 31 may be used as a trademark or an image. When the material of the first electrode 31 is a transparent material, the transmittance of the electronic device may be improved.

In one embodiment of the present disclosure, as shown in FIG. 1A, the electronic device may further include a seal 13 disposed between the first substrate 11 and the second substrate 12 and surrounding the light modulation layer 2. In the present disclosure, the seal 13 may be a sealing material, such as a thermal curing material, a photochemical curing material, or a thermal light curing material, but the present disclosure is not limited thereto.

In one embodiment of the present disclosure, as shown in FIG. 1A and FIG. 1B, in the normal direction Z of the first substrate 11, the antenna structure 3 and the light modulation layer 2 at least partially overlap, for example, the first electrode 31 of the antenna structure 3 and the light modulation layer 2 may at least partially overlap. The first electrode 31 of the antenna structure 3 may be, for example, locally disposed, and the first electrode 31 may selectively be a patterned electrode, so that the light transmittance of the electronic device may be increased. In one embodiment of the present disclosure, as shown in FIG. 1B, the first electrode 31 may include a first portion 31A and a second portion 31B. The first portion 31A extends along a first direction X, and the second portion 31B is electrically connected to the first portion 31A. In one embodiment of the present disclosure, the first portion 31A may be a micro-strip, which may be electrically connected to the hub 100 through the wire W to transmit the signal to the hub 100. The second portion 31B may include a plurality of block structures for receiving or sending signals, and the block structures may be connected in series and/or in parallel. In the present disclosure, in the normal direction Z of the first substrate 11, the shape of the block structure is not particularly limited, for example, it may be circular, elliptical, rectangular, triangular, pentagonal, irregular or other suitable shapes, wherein FIG. 1B uses an inverted T shape as an example, but the present disclosure is not limited thereto. When the extension direction (for example, the first direction X) of the first portion 31A is substantially parallel to the long side of the electronic device, insertion loss may be reduced, but the present disclosure is not limited thereto. In more detail, as shown in FIG. 1B, in the normal direction Z of the first substrate 11, the first substrate 11 has a first edge 11e1 and a second edge 11e2 that are adjacent and connected with each other, the first edge 11e1, for example, extends along a first direction X, and the second edge 11e2, for example, extends along a second direction Y, wherein the first direction X is different from the second direction Y, for example, the first direction X is approximately perpendicular to the second direction Y, the length of the first edge 11e1 may, for example, be greater than the length of the second edge 11e2, and the extension direction of the first portion 31A of the first electrode 31 is, for example, approximately parallel to the first edge 11e1, but it is not limited thereto.

In one embodiment of the present disclosure, as shown in FIG. 1A and FIG. 1B, the electronic device may further include an optical component 5, which is disposed on a surface 11s1 of the first substrate 11 away from the light modulation layer 2, wherein in the normal direction Z of the first substrate 11, the optical component 5 and the first electrode 31 do not overlap. The optical component 5 is, for example, adjacent to the first electrode 31. The optical component 5 includes a transmittance-reducing layer or structure, which may be used to improve optical defects such as uneven light transmission or color shift caused by the first electrode 31, thereby improving the taste of the electronic device. The optical component 5 may include a polarizer, an optical component having a grating structure or a color resist layer, or a combination thereof, but the present disclosure is not limited thereto. In one embodiment, the optical component 5 includes, for example, an organic or inorganic coating, such as a thin film formed by alternating multiple layers of silicon nitride (SiNx) and silicon oxide (SiOx), so as to reduce the reflectivity of the electronic device to ambient light. In one embodiment, the optical component 5 may include an anti-ultraviolet film to reduce the damage of ultraviolet light to the electronic device, extend the life of the electronic device, and reduce the amount of harmful light entering the room. In one embodiment, the optical component 5 may include a color filter to customize the desired color. In one embodiment of the present disclosure, the optical component 5 may be selectively omitted in the electronic device, but the present disclosure is not limited thereto.

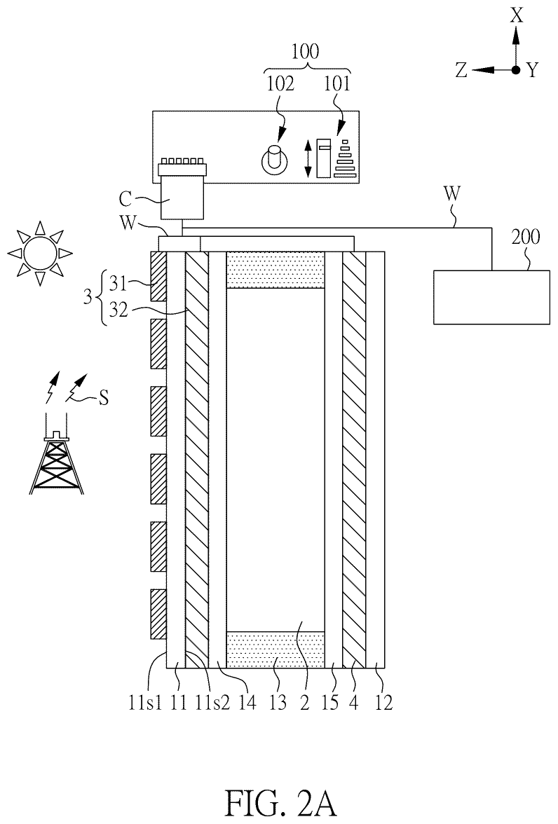

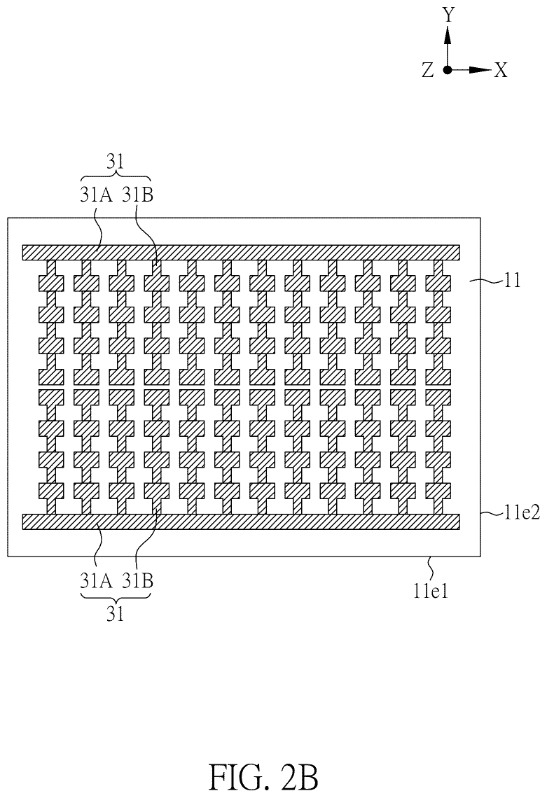

FIG. 2A is a schematic cross-sectional view of a portion of an electronic device according to an embodiment of the present disclosure, and FIG. 2B is a schematic top view of a portion of an electronic device according to an embodiment of the present disclosure, wherein FIG. 2A and FIG. 2B are similar to the electronic device of FIG. 1A and 1B, except for the following differences.

In one embodiment of the present disclosure, when the light modulation layer 2 includes a liquid crystal material, as shown in FIG. 2A, the electronic device may further include a first alignment layer 14 and a second alignment layer 15, the first alignment layer 14 is disposed between the second electrode 32 and the light modulation layer 2, and the second alignment layer 15 is disposed between the further electrode 4 and the light modulation layer 2. The first alignment layer 14 and the second alignment layer 15 may align the liquid crystal material in the light modulation layer 2 substantially in a fixed direction.

In one embodiment of the present disclosure, as shown in FIG. 2A and FIG. 2B, in the normal direction Z of the first substrate 11, the antenna structure 3 may overlap with the light modulation layer 2, for example, the first electrode 31 of the antenna structure 3 may overlap with the light modulation layer 2. The first electrode 31 of the antenna structure 3 may be, for example, disposed on the entire surface, and the first electrode 31 may selectively be a patterned electrode, so that the light transmittance of the electronic device may be increased. In one embodiment of the present disclosure, as shown in FIG. 2B, the first electrode 31 may include a plurality of first portions 31A and a plurality of second portions 31B. The first portions 31A extend along the first direction X, and the second portions 31B are electrically connected to the first portions 31A. In FIG. 2B, two sets of first portions 31A and second portions 31B are taken as an example, but the present disclosure is not limited thereto, and the number and location of the first portions 31A and the second portions 31B may be adjusted as needed. In one embodiment of the present disclosure, the first portion 31A may be a micro-strip for transmitting signals to the hub 100. The second portion 31B may include a plurality of block structures for receiving or sending signals, and the block structures may be connected in series and/or in parallel. In the present disclosure, in the normal direction Z of the first substrate 11, the shape of the block structure is not particularly limited, for example, it may be circular, elliptical, rectangular, triangular, pentagonal, irregular or other suitable shapes, wherein T-shape and inverted T-shape are used as an example in FIG. 2B, but the present disclosure is not limited thereto. When the extension direction (for example, the first direction X) of the first portion 31A is parallel to the long side of the electronic device, that is, when the extension direction of the first portion 31A is substantially parallel to the first edge 11e1, insertion loss may be reduced.

In the present disclosure, the features of other components and materials of the electronic device may be as described above and will not be repeated here.

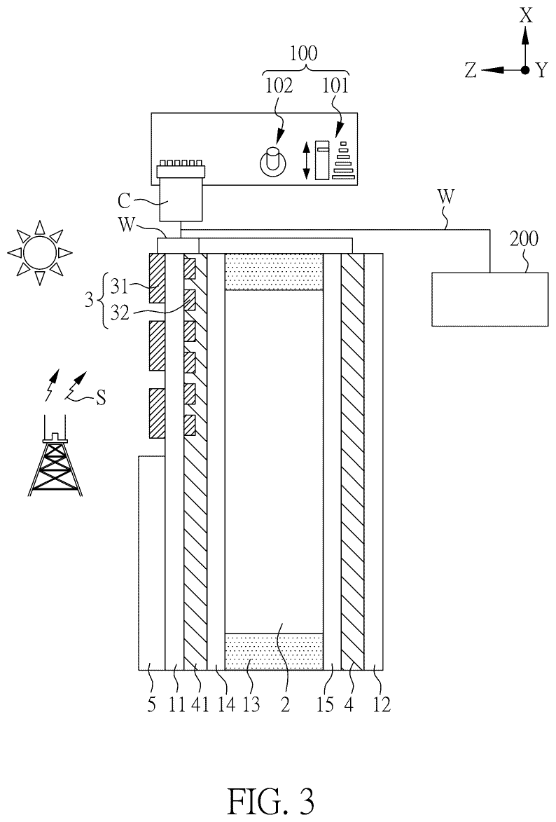

FIG. 3 is a schematic cross-sectional view of a portion of an electronic device according to an embodiment of the present disclosure. The electronic device of FIG. 3 is similar to that of FIG. 1A and FIG. 1B, except for the following differences.

In one embodiment of the present disclosure, when the light modulation layer 2 includes a liquid crystal material, as shown in FIG. 3, the electronic device may further include a first alignment layer 14 and a second alignment layer 15, the first alignment layer 14 is disposed between the second electrode 32 and the light modulation layer 2, and the second alignment layer 15 is disposed between the further electrode 4 and the light modulation layer 2. The first alignment layer 14 and the second alignment layer 15 may align the liquid crystal material in the light modulation layer 2 substantially in a fixed direction.

In one embodiment of the present disclosure, as shown in FIG. 3, the electronic device may further include a third electrode 41 disposed between the first substrate 11 and the light modulation layer 2, and used to drive the light modulation layer 2, wherein the third electrode 41 is electrically connected to the second electrode 32. The third electrode 41 and the further electrode 4 may be used as electrodes for driving the light modulation layer 2. By applying voltage to the third electrode 41 and the further electrode 4, the light modulation layer 2 may be switched between the light-shielding state and the light-transmitting state, so that the electronic device may achieve a light-shielding effect or a light-transmitting effect.

In one embodiment of the present disclosure, as shown in FIG. 3, the second electrode 32 and the third electrode 41 may be electrically connected through direct contact, for example, the second electrode 32 may be embedded in the third electrode 41, wherein the materials of the second electrode 32 and the third electrode 41 are different, the transmittance of the third electrode 41 is, for example, higher than the transmittance of the second electrode 32, and the conductivity of the second electrode 32 is, for example, greater than the conductivity of the third electrode 41.

Alternatively, although not shown in the figures, other components may be included between the second electrode 32 and the third electrode 41, and the second electrode 32 and the third electrode 41 may be electrically connected through a conductive through hole or the like. In one embodiment of the present disclosure, in the normal direction Z of the first substrate 11, the optical component 5 does not overlap with the first electrode 31 and the second electrode 32.

In the present disclosure, the materials of the first electrode 31 and the second electrode 32 may each include a metal material, a metal oxide material, an alloy thereof or a combination thereof, for example, may include gold, silver, copper, palladium, platinum, ruthenium, aluminum, cobalt, nickel, titanium, molybdenum, manganese, indium zinc oxide (IZO), indium tin oxide (ITO), indium tin zinc oxide (ITZO), indium gallium zinc oxide (IGZO), or aluminum zinc oxide (AZO), but the present disclosure is not limited thereto. When the material of the second electrode 32 includes metal, the transmission effect of the antenna structure 3 in receiving or sending signals may be improved. In the present disclosure, the materials of the third electrode 41 and the further electrode 4 may each include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In one embodiment of the present disclosure, the top view schematic diagram of the electronic device in FIG. 3 may refer to that shown in FIG. 1B, and will not be described in detail herein. In one embodiment of the present disclosure, the optical component 5 of the electronic device of FIG. 3 may be selectively omitted, and the first electrode 31 of the antenna structure 3 may be, for example, disposed on the entire surface. Thus, the top view schematic diagram of the electronic device may refer to, for example, FIG. 2B, which is not repeated here. In addition, the features of other components and materials of the electronic device may be as described above and will not be described in detail herein.

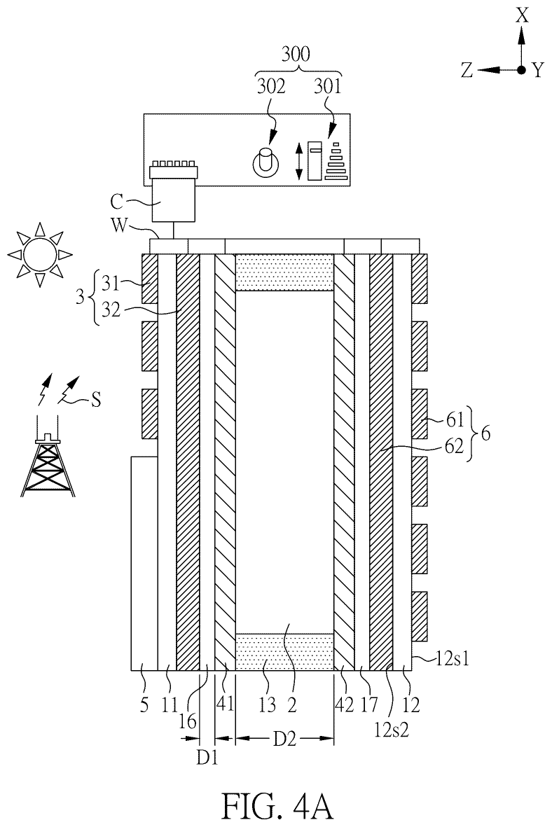

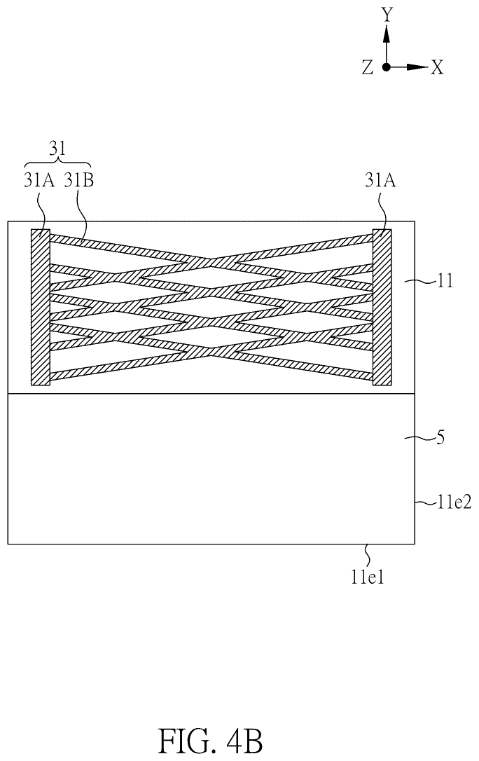

FIG. 4A is a schematic cross-sectional view of a portion of an electronic device according to an embodiment of the present disclosure, and FIG. 4B is a schematic top view of a portion of an electronic device according to an embodiment of the present disclosure, wherein the electronic device of FIG. 4A and FIG. 4B is similar to that of FIG. 1A and FIG. 1B, except for the following differences.

In one embodiment of the present disclosure, as shown in FIG. 4A, the electronic device may further include: a third electrode 41 disposed between the first substrate 11 and the light modulation layer 2, and used to drive the light modulation layer 2; a fourth electrode 42 disposed between the second substrate 12 and the light modulation layer 2, and used to drive the light modulation layer 2; and an insulation layer 16 disposed between the second electrode 32 and the third electrode 41, wherein, in the normal direction Z of the first substrate 11, the distance D1 between the third electrode 41 and the second electrode 32 is smaller than the distance D2 between the third electrode 41 and the fourth electrode 42. The distance D1 is, for example, an average of distances measured by taking any three locations between the third electrode 41 and the second electrode 32. The distance D2 is, for example, an average of distances measured by taking any three locations between the third electrode 41 and the fourth electrode 42. By applying voltage to the third electrode 41 and the fourth electrode 42, the light modulation layer 2 is switched between a non-light-transmitting state (for example, a light-shielding state, a color changing state, or a haze state) and a light-transmitting state, so that the electronic device may achieve a non-light-transmitting effect or a light-transmitting effect.

In one embodiment of the present disclosure, as shown in FIG. 4A, the electronic device may also include: a further antenna structure 6, having a fifth electrode 61 and a sixth electrode 62, wherein the fifth electrode 61 is disposed on a surface 12s1 of the second substrate 12 away from the light modulation layer 2, the sixth electrode 62 is disposed between the second substrate 12 and the light modulation layer 2, and the sixth electrode 62 is used to receive the ground voltage. The further antenna structure 6 may be used to receive or send signals.

In one embodiment of the present disclosure, as shown in FIG. 4A, the second substrate 12 has a surface 12s1 away from the light modulation layer 2, and a surface 12s2 adjacent to the light modulation layer 2, wherein the fifth electrode 61 is disposed adjacent to the surface 12s1, and the sixth electrode 62 is disposed adjacent to the surface 11s2. In one embodiment of the present disclosure, the fifth electrode 61 may contact the surface 12s1 of the second substrate 12, and the sixth electrode 62 may contact the surface 12s2 of the second substrate 12, but the present disclosure is not limited thereto. In one embodiment of the present disclosure, as shown in FIG. 4A, the electronic device may further include a further insulation layer 17 disposed between the light modulation layer 2 and the sixth electrode 62. In one embodiment of the present disclosure, as shown in FIG. 4A, the electronic device may also include a further insulation layer 17 disposed between the fourth electrode 42 and the sixth electrode 62.

In one embodiment of the present disclosure, as shown in FIG. 4A, the hub and the client equipment may be integrated into a control system 300. The control system 300 may be electrically connected to the first electrode 31, the second electrode 32, the third electrode 41, the fourth electrode 42, the fifth electrode 61 and/or the sixth electrode 62 through the circuit board C and the wire W, thereby controlling the light modulation layer 2, the antenna structure 3 and/or the further antenna structure 6. In more detail, the control system 300 may selectively include a dimming system 301 and/or an antenna switch 302, but it is not limited thereto. The dimming system 301 may be, for example, a dimming button. By turning the dimming button, the electric field strength applied to the third electrode 41 and the fourth electrode 42 may be adjusted, so that the light modulation layer 2 presents different levels of non-light-transmitting state (such as color-changing state, light-shielding state or haze state) and light-transmitting state according to the electric field strength. The antenna switch 302 may be, for example, a button, which drives the antenna structure 3 and/or the further antenna structure 6 to receive or send signals by pressing the button, but it is not limited thereto.

In one embodiment of the present disclosure, as shown in FIG. 4A, a mobile communication signal S (for example, a 4G signal, a 5G signal and/or a 6G signal, etc.) outside the electronic device may be received through the antenna structure 3 and transmitted to the control system 300. The control system 300 may convert the received signal into, for example, a Wi-Fi signal and provide the Wi-Fi signal to the further antenna structure 6. The further antenna structure 6 may send the signal to a user inside the electronic device (not shown), thereby alleviating the problem that the signal is not easy to pass through the electronic device.

In the present disclosure, the materials of the insulation layer 16 and the further insulation layer 17 may each include silicon oxide, silicon nitride, silicon oxynitride, other suitable materials or a combination thereof, but the present disclosure is not limited thereto. In the present disclosure, the materials of the second electrode 32, the third electrode 41, the fourth electrode 42, the fifth electrode 61 and the sixth electrode 62 may each include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In one embodiment of the present disclosure, as shown in FIG. 4A and FIG. 4B, the first electrode 31 of the antenna structure 3 may be locally disposed, and the first electrode 31 may be selectively a patterned electrode, thereby increasing the light transmittance of the electronic device. In one embodiment of the present disclosure, as shown in FIG. 4B, the first electrode 31 may include a first portion 31A and a second portion 31B. The first portion 31A extends along the second direction Y, and the second portion 31B is electrically connected to the first portion 31A. In one embodiment of the present disclosure, the first portion 31A may be a micro-strip, which may be electrically connected to the control system 300 through the wire W to transmit the signal to the control system 300. In one embodiment of the present disclosure, the second portion 31B may be of a mesh design, which may be formed by a plurality of strip structures arranged crosswise with each other, wherein the number and crossing angle of the strip structures are not particularly limited and may be adjusted as needed.

In one embodiment of the present disclosure, as shown in FIG. 4A, the fifth electrode 61 of the further antenna structure 6 may be, for example, disposed on the entire surface, and the fifth electrode 61 may be selectively a patterned electrode, thereby increasing the light transmittance of the electronic device. The fifth electrode 61 may include a block structure as shown in FIG. 2B, or may include a strip structure as shown in FIG. 4B, which will not be described in detail herein. In one embodiment of the present disclosure, in the normal direction Z of the first substrate 11, the optical component 5 may partially overlap with the fifth electrode 61. In one embodiment of the present disclosure, the fifth electrode 61 may be selectively disposed locally, and thus, its top view may be, for example, that shown in the first electrode 31 of FIG. 1B or FIG. 4B, which will not be described in detail herein.

In one embodiment of the present disclosure, when the light modulation layer 2 includes a liquid crystal material, the electronic device may further include a first alignment layer 14 and a second alignment layer 15 as shown in FIG. 2A, which will not be described in detail herein. In one embodiment of the present disclosure, in the electronic device, the provision of the further antenna structure 6 may be selectively omitted, which will not be described in detail herein. In addition, the features of other components and materials of the electronic device may be as described above and will not be described in detail herein.

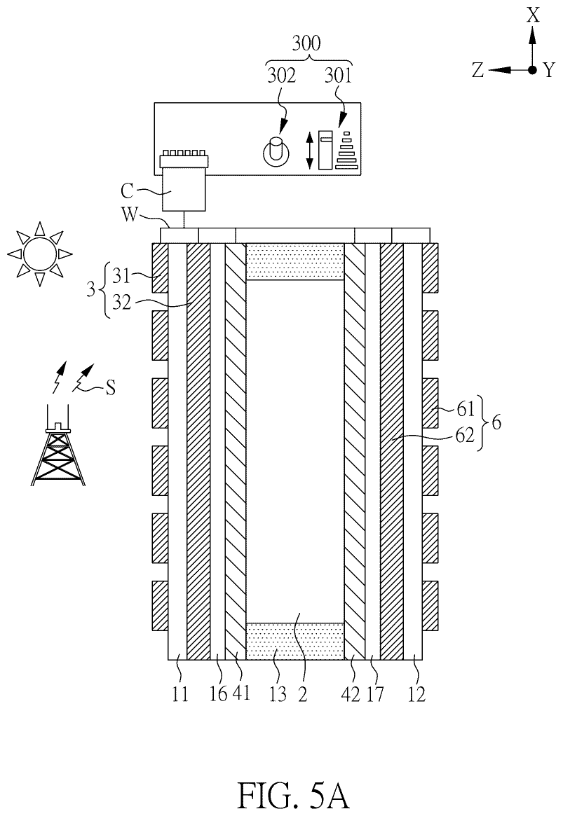

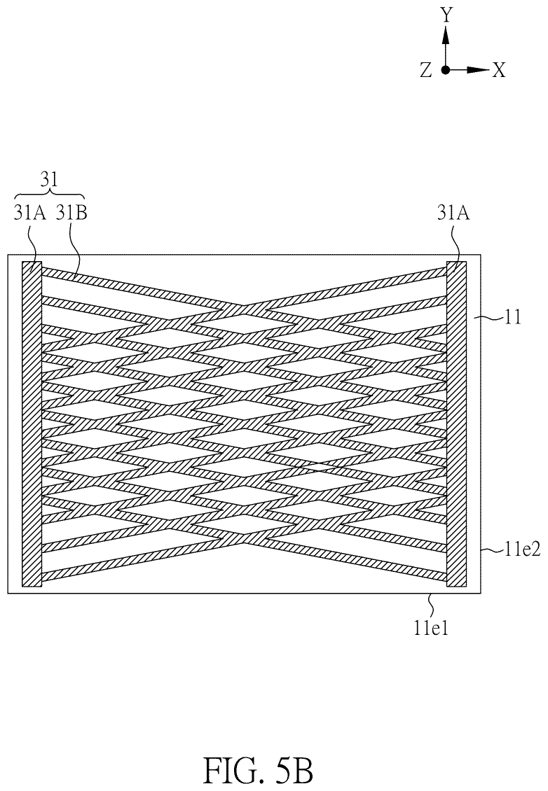

FIG. 5A is a schematic cross-sectional view of a portion of an electronic device according to an embodiment of the present disclosure, and FIG. 5B is a schematic top view of a portion of an electronic device according to an embodiment of the present disclosure, wherein the electronic device of FIG. 5A and FIG. 5B is similar to that of FIG. 4A and FIG. 4B, except for the following differences.

In one embodiment of the present disclosure, as shown in FIG. 5A and FIG. 5B, in the normal direction Z of the first substrate 11, the antenna structure 3 may overlap with the light modulation layer 2, for example, the first electrode 31 of the antenna structure 3 may overlap with the light modulation layer 2. The first electrode 31 of the antenna structure 3 may be, for example, disposed on the entire surface, and the first electrode 31 may selectively be a patterned electrode, so that the light transmittance of the electronic device may be increased. In one embodiment of the present disclosure, as shown in FIG. 5B, the first electrode 31 may include a plurality of first portions 31A and a plurality of second portions 31B. The first portions 31A extend along the second direction Y, and the second portions 31B are electrically connected to the first portions 31A. In FIG. 5B, two first portions 31A and one second portion 31B are taken as an example, but the present disclosure is not limited thereto, and the number and location of the first portions 31A and the second portions 31B may be adjusted as needed. In one embodiment of the present disclosure, the first portion 31A may be a micro-strip for transmitting signals to the control system 300. The second portion 31B may be of a mesh design, which may be formed by a plurality of strip structures arranged crosswise with each other, wherein the number and cross angle of the strip structures are not particularly limited and may be adjusted as needed.

In one embodiment of the present disclosure, when the light modulation layer 2 includes a liquid crystal material, the electronic device may further include a first alignment layer 14 and a second alignment layer 15 as shown in FIG. 2A, which will not be described in detail herein. In one embodiment of the present disclosure, in the electronic device, the provision of the further antenna structure 6 may be selectively omitted, which will not be described in detail herein. In addition, the features of other components and materials of the electronic device may be as described above and will not be described in detail herein.

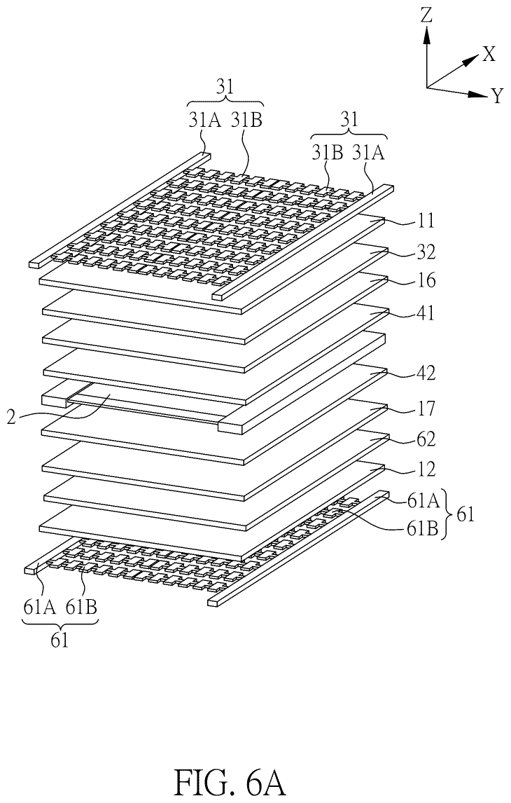

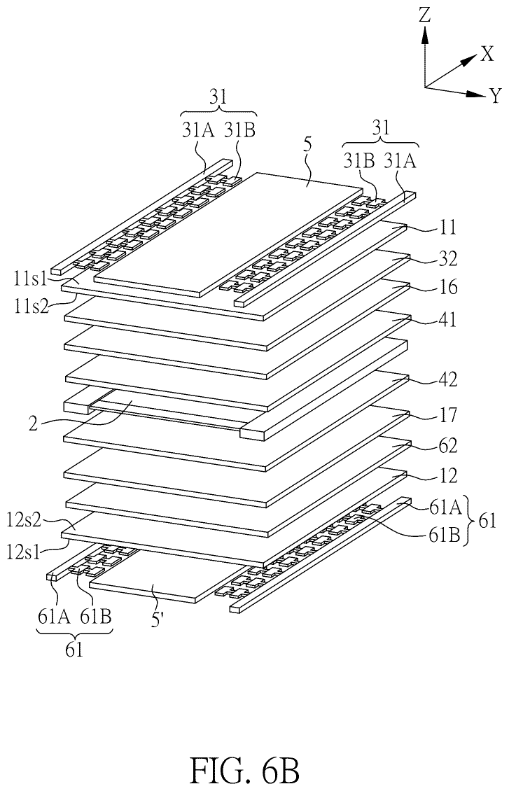

FIG. 6A is a three-dimensional schematic diagram of a portion of an electronic device according to an embodiment of the present disclosure, wherein the electronic device of FIG. 6A is similar to that of FIG. 5A and FIG. 5B, except for the following differences.

In one embodiment of the present disclosure, as shown in FIG. 6A, the first electrode 31 of the antenna structure 3 may be disposed on the entire surface, and the first electrode 31 may be selectively a patterned electrode, thereby increasing the light transmittance of the electronic device. In one embodiment of the present disclosure, as shown in FIG. 6A, the first electrode 31 may include a plurality of first portions 31A and a plurality of second portions 31B. The first portions 31A extend along the first direction X, and the second portions 31B are electrically connected to the first portions 31A. In FIG. 6A, two sets of first portions 31A and second portions 31B are taken as an example, but the present disclosure is not limited thereto, and the number and location of the first portions 31A and the second portions 31B may be adjusted as needed. In one embodiment of the present disclosure, the first portion 31A may be a micro-strip for transmitting signals to the control system 300 (as shown in FIG. 5A). The second portion 31B may include a plurality of block structures for receiving or sending signals, and the block structures may be connected in series and/or in parallel. In the present disclosure, in the normal direction Z of the first substrate 11, the shape of the block structure is not particularly limited, for example, it may be circular, elliptical, rectangular, triangular, pentagonal, irregular or other suitable shapes, wherein in FIG. 6A, T-shape and inverted T-shape are used as examples, but the present disclosure is not limited thereto.

Similarly, as shown in FIG. 6A, the fifth electrode 61 of the antenna structure 3 may be disposed on the entire surface, and the fifth electrode 61 may be selectively a patterned electrode, thereby increasing the light transmittance of the electronic device. In one embodiment of the present disclosure, as shown in FIG. 6A, the fifth electrode 61 may include a plurality of third portions 61A and a plurality of fourth portions 61B. The third portions 61A extend along the first direction X, and the fourth portions 61B are electrically connected to the third portions 61A. In FIG. 6A, two sets of third portions 61A and fourth portions 61B are taken as an example, but the present disclosure is not limited thereto, and the number and location of the third portions 61A and fourth portions 61B may be adjusted as needed. In one embodiment of the present disclosure, the third portion 61A may be a micro-strip for transmitting signals to the control system 300 (as shown in FIG. 5A). The fourth portion 61B may include a plurality of block structures for receiving or sending signals, and the block structures may be connected in series and/or in parallel. In the present disclosure, in the normal direction Z of the first substrate 11, the shape of the block structure is not particularly limited, for example, it may be circular, elliptical, rectangular, triangular, pentagonal, irregular or other suitable shapes, wherein in FIG. 6A, T-shape and inverted T-shape are used as examples, but the present disclosure is not limited thereto.

In one embodiment of the present disclosure, when the light modulation layer 2 includes a liquid crystal material, the electronic device may further include a first alignment layer 14 and a second alignment layer 15 as shown in FIG. 2A, which will not be described in detail herein. In one embodiment of the present disclosure, in the electronic device, the provision of the further antenna structure 6 may be selectively omitted, which will not be described in detail herein. In addition, the features of other components and materials of the electronic device may be as described above and will not be described in detail herein.

FIG. 6B is a three-dimensional schematic diagram of a portion of an electronic device according to an embodiment of the present disclosure. The electronic device of FIG. 6B is similar to that of FIG. 6A, except for the following differences.

In one embodiment of the present disclosure, as shown in FIG. 6B, the first electrode 31 of the antenna structure 3 may be locally disposed, and the first electrode 31 may be selectively a patterned electrode, thereby increasing the light transmittance of the electronic device. In one embodiment of the present disclosure, as shown in FIG. 6B, the first electrode 31 may include a plurality of first portions 31A and a plurality of second portions 31B. The first portions 31A extend along the first direction X, and the second portions 31B are electrically connected to the first portions 31A. In FIG. 6B, two sets of first portions 31A and second portions 31B are taken as an example, but the present disclosure is not limited thereto, and the number, location and/or area of the first portions 31A and the second portions 31B may be adjusted as needed. The first portion 31A may be a micro-strip for transmitting signals to the control system 300 (as shown in FIG. 5A). The second portion 31B may include a plurality of block structures for receiving or sending signals, and the block structures may be connected in series and/or in parallel. In the present disclosure, in the normal direction Z of the first substrate 11, the shape of the block structure is not particularly limited, for example, it may be circular, elliptical, rectangular, triangular, pentagonal, irregular or other suitable shapes, wherein in FIG. 6B, T-shape and inverted T-shape are used as examples, but the present disclosure is not limited thereto.

Similarly, as shown in FIG. 6B, the fifth electrode 61 of the antenna structure 3 may be locally disposed, and the fifth electrode 61 may be selectively a patterned electrode, thereby increasing the light transmittance of the electronic device. In one embodiment of the present disclosure, as shown in FIG. 6B, the fifth electrode 61 may include a plurality of third portions 61A and a plurality of fourth portions 61B. The third portions 61A extend along the first direction X, and the fourth portions 61B are electrically connected to the third portions 61A. In FIG. 6B, two sets of third portions 61A and fourth portions 61B are taken as an example, but the present disclosure is not limited thereto, and the number, location and/or area of the third portions 61A and the fourth portions 61B may be adjusted as needed.

In one embodiment of the present disclosure, as shown in FIG. 6B, the electronic device may further include an optical component 5 and a further optical component 5′, the optical component 5 is disposed on a surface 11s1 of the first substrate 11 away from the light modulation layer 2, the further optical component 5′ is disposed on a surface 12s1 of the second substrate 12 away from the light modulation layer 2, the optical component 5 is adjacent to the first electrode 31, and the further optical component 5′ is adjacent to the fifth electrode 61, wherein, in the normal direction Z of the first substrate 11, the optical component 5 does not overlap with the first electrode 31, and the further optical component 5′ does not overlap with the fifth electrode 61. In one embodiment of the present disclosure, as shown in FIG. 6B, in the second direction Y, the optical component 5 is disposed between the second portions 31B of the two first electrodes 31. In one embodiment of the present disclosure, as shown in FIG. 6B, in the second direction Y, the further optical component 5′ is disposed between the fourth portions 61B of two fifth electrodes 61. The ranges or patterns of the second portions 31B of the plurality of first electrodes 31 may be the same or different. The ranges or patterns of the fourth portions 61B of the plurality of fifth electrodes 61 may be the same or different. The second portions 31B of the plurality of first electrodes 31 may at least partially overlap with the fourth portions 61B of the plurality of fifth electrodes 61. In the normal direction Z of the first substrate 11, the optical component 5 and the further optical component 5′ may overlap or not overlap with each other.

In one embodiment of the present disclosure, in the electronic device, the provision of the further antenna structure 6 may be selectively omitted, which will not be described in detail herein. In addition, the features of other components and materials of the electronic device may be as described above and will not be described in detail herein.

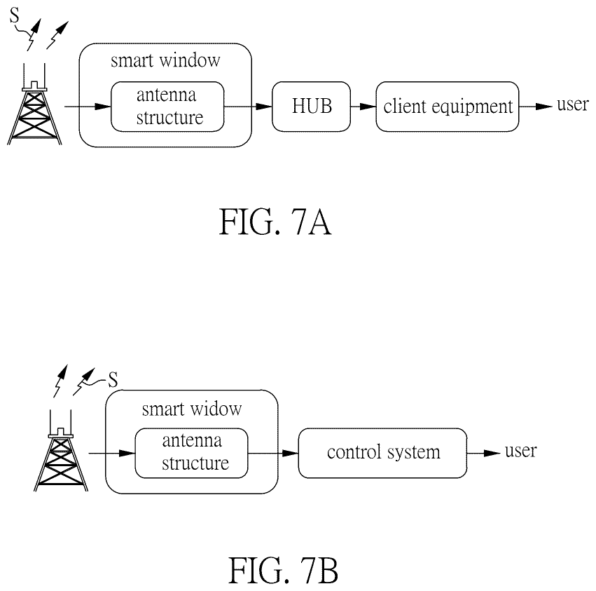

FIG. 7A and FIG. 7B are respectively signal transmission block diagrams according to an embodiment of the present disclosure.

In one embodiment of the present disclosure, when the electronic device includes a hub and a client equipment, the path for the signal to be transmitted from outside the electronic device to the user may be, for example, as shown in FIG. 7A. The base station outside the electronic device sends a mobile communication signal S, which may be received by, for example, an antenna structure in a smart window and transmitted to a hub. The hub provides the received signal to a client equipment, which converts the signal into, for example, a Wi-Fi signal and provides the Wi-Fi signal to a user inside the electronic device, so that the mobile communication signal S may be transmitted from outside the electronic device to inside the electronic device and provided to the user, but it is not limited thereto. The detailed structural features of the electronic device may be described in any one of FIG. 1A to FIG. 6B, and will not be described in detail herein.

In one embodiment of the present disclosure, when the electronic device includes a control system that integrates a hub and a client equipment, the path for signals to be transmitted from outside the electronic device to the user may be as shown in FIG. 7B. The base station outside the electronic device sends a mobile communication signal S, which may be received by, for example, an antenna structure in a smart window and transmitted to a control system. The control system may convert the received signal into, for example, a Wi-Fi signal and provide the Wi-Fi signal to a user inside the electronic device, so that the mobile communication signal S may be transmitted from the outside of the electronic device to the inside of the electronic device and provided to the user. The detailed structural features of the electronic device may be described in any one of FIG. 1A to FIG. 6B, and will not be described in detail herein.

The present disclosure combines the antenna structure 3 with the light modulation layer 2 to enable the electronic device to have the function of receiving and/or sending signals while achieving a light-shielding or light-transmitting effect, thereby alleviating the problem of poor signal penetration of the electronic device.

The aforementioned specific embodiments should be interpreted as merely illustrative, and not limiting the rest of the present disclosure in any way, and the features of different embodiments may be mixed and matched as long as they do not conflict with each other.

1. An electronic device, comprising:
a first substrate;
a second substrate opposite to the first substrate;
a light modulation layer disposed between the first substrate and the second substrate; and
an antenna structure having a first electrode and a second electrode, wherein the first electrode is disposed on a surface of the first substrate away from the light modulation layer, the second electrode is disposed between the first substrate and the light modulation layer, and the second electrode is used to receive a ground voltage.

2. The electronic device as claimed in claim 1, wherein the second electrode is further used to drive the light modulation layer.

3. The electronic device as claimed in claim 1, further comprising:
a third electrode disposed between the first substrate and the light modulation layer and used to drive the light modulation layer; and
a fourth electrode disposed between the second substrate and the light modulation layer and used to drive the light modulation layer.

4. The electronic device as claimed in claim 3, further comprising an insulation layer disposed between the second electrode and the third electrode, wherein, in the normal direction of the first substrate, a distance between the third electrode and the second electrode is smaller than a distance between the third electrode and the fourth electrode.

5. The electronic device as claimed in claim 3, wherein the third electrode is electrically connected to the second electrode.

6. The electronic device as claimed in claim 3, further comprising a further antenna structure having a fifth electrode and a sixth electrode, wherein the fifth electrode is disposed on a surface of the second substrate away from the light modulation layer, the sixth electrode is disposed between the second substrate and the light modulation layer, and the sixth electrode is used to receive a ground voltage.

7. The electronic device as claimed in claim 6, further comprising a further insulation layer disposed between the fourth electrode and the sixth electrode.

8. The electronic device as claimed in claim 1, wherein the light modulation layer includes at least one of liquid crystal material, suspended particles or electrochromic material.

9. The electronic device as claimed in claim 1, wherein, in a normal direction of the first substrate, the antenna structure and the light modulation layer at least partially overlap.

10. The electronic device as claimed in claim 1, further comprising a hub and a client equipment, wherein the client equipment is electrically connected to the hub, and the hub is electrically connected to the first electrode and the second electrode.

11. The electronic device as claimed in claim 1, further comprising an optical component disposed on the surface of the first substrate away from the light modulation layer, wherein, in the normal direction of the first substrate, the optical component and the first electrode do not overlap.

12. The electronic device as claimed in claim 2, further comprising a further electrode disposed between the second substrate and the light modulation layer, and used to drive the light modulation layer.

13. The electronic device as claimed in claim 12, wherein materials of the second electrode and the further electrode each include a transparent conductive material.

14. The electronic device as claimed in claim 1, further comprising a seal disposed between the first substrate and the second substrate and configured to surround the light modulation layer.

15. The electronic device as claimed in claim 1, wherein the first electrode includes a first portion and a second portion, the first portion extends along a first direction, the second portion is electrically connected to the first portion, the first portion is a micro-strip, and the second portion includes a plurality of block structures.

16. The electronic device as claimed in claim 12, further comprising a first alignment layer disposed between the second electrode and the light modulation layer, and a second alignment layer disposed between the further electrode and the light modulation layer.

17. The electronic device as claimed in claim 5, wherein the second electrode is embedded in the third electrode.

18. The electronic device as claimed in claim 17, wherein a transmittance of the third electrode is higher than a transmittance of the second electrode.

19. The electronic device as claimed in claim 17, wherein a conductivity of the second electrode is greater than a conductivity of the third electrode.

20. The electronic device as claimed in claim 1, wherein the first electrode is a patterned electrode.
